(19) United States
(12) Patent Application Publication
(10) Pub. No.: US 2026/0131411 A1
(43) Pub. Date: May 14, 2026

(54) ROTARY-DIAL MOUNTING BRACKETS FOR PART-TO-PART ALIGNMENT AND METHODS FOR MAKING AND USING SUCH MOUNTING BRACKETS

(71) Applicant: GM GLOBAL TECHNOLOGY OPERATIONS LLC, Detroit, MI (US)

(72) Inventor: Ricardo Pineda Sánchez, Zinacantepec (MX)

(73) Assignee: GM GLOBAL TECHNOLOGY OPERATIONS LLC, Detroit, MI (US)

(21) Appl. No.: 18/941,505

(22) Filed: Nov. 8, 2024

(51) Int. Cl. B23P 19/12; B62D 27/02

(52) U.S. Cl. CPC B23P 19/12; B62D 27/02

(57) ABSTRACT

A mounting bracket for assembling first and second components includes a bracket body that is rotatable with respect to the two components and includes a circular array of fastener through-holes, each of which passes a threaded fastener therethrough and into a threaded hole in the first component to thereby fasten the mounting bracket to the first component. Projecting from a central region of the bracket body is a locator pin that inserts into a pin aperture in the second component to thereby attach the mounting bracket and the first component to the second component. One pair of the fastener holes is located diametrically opposite from each other across the locator pin and both located a shared radial distance from the locator pin. Another pair of fastener holes is located diametrically opposite from each other across the locator pin and each located a distinct distance from the locator pin.

### INTRODUCTION

The present disclosure relates generally to locating features for aligning parts during part-to-part assembly. More specifically, aspects of this disclosure relate to mounting brackets for aligning door panels during manufacture of vehicle door assemblies.

Current production motor vehicles, such as the modern-day automobile, are originally equipped with compartment closure assemblies that are movably mounted to the vehicle body to cover and provide controlled access to the vehicle's various interior compartments. In automotive applications, for example, driver-side and passenger-side vehicle doors can be opened and closed to allow authorized user access for entering and exiting the passenger compartment. In contrast, the engine hood (or “bonnet” in some countries) extends over and covers the vehicle's engine compartment to prevent theft or damage of the engine components while allowing access for repairs and maintenance. A trunk lid, on the other hand, is hinged underneath the passenger compartment's rear (or front) deck to cover a trunk compartment located at the rear (or front) of the vehicle. By comparison, pickup trucks, sport utility vehicles (SUV), box trucks, and other cargo transport vehicles may be typified by a rear cargo compartment that is closed off at the tail end of the vehicle body by a hinged liftgate, tailgate, or dual door assembly.

To interconnect the constituent parts that form a vehicle compartment closure assembly, complementary parts may be located with respect to each other by mating features that are oversized or undersized to provide part-to-part play. Delimited spacing of this nature enables production line operators to freely move the parts relative to each other to ensure proper alignment during the assembly process. Controlled part-to-part spacing may be provided by a two-way mounting bracket that is fastened to one component and includes male alignment features, such as protruding bosses. The male alignment features are received in corresponding female alignment features, such as through-holes or recessed slots, in the other component. Typically, there is clearance between each male alignment feature and its respective female alignment feature to accommodate anticipated size and positional variances of the mating parts resulting from manufacturing variation tolerances. Once aligned, the parts may be secured together by fasteners, clips, heatstaking, etc.

### SUMMARY

Presented herein are rotary-dial mounting brackets for part-to-part alignment during assembly manufacture, methods for making and methods for using such mounting brackets, and motor vehicles with vehicle door assemblies constructed using such mounting brackets. By way of non-limiting example, a rotary dial bracket is fabricated with a circular array of fastener through-holes that circumscribes a central locator pin. The circumferentially spaced fastener holes are mated in pairs in which the holes of each pair are located diametrically opposite each other across the central locator pin. Each mated pair of fastener holes is the same distance from each other as the fastener holes in the other mated hole pairs (e.g., shared hole-to-hole distance of about 44 millimeters (mm)). However, only one mated hole pair comprises fastener holes that are equidistant from the central locator pin (e.g., each fastener hole in a first (0:0 origin) pair has a radial distance of about 22 mm). The fastener holes in the other mated hole pairs, in contrast, each has a distinct distance to the central locator pin. For instance, a second (−1:+1 offset) pair has one fastener hole with a radial distance of about 21 mm to the central locator pin and the other fastener hole has a radial distance of about 23 mm to the central locator pin.

For simplicity of design and manufacture, the rotary dial bracket may be injection molded or die cast as a one-piece structure from a high-strength polymeric or metallic material (e.g., Acrylonitrile Butadiene Styrene (ABS) or 6061 aluminum alloy). The resultant bracket body may be substantially flat and may have an asymmetric plan-view profile. The bracket body may have optional spur gear-like teeth spaced around and projecting radially outward from the perimeter of the bracket body. The central locator pin may be a frustoconical boss that projects orthogonally from a central region of the bracket body. It may be desirable that the center of the circular array of fastener through-holes be eccentric with (i.e., radially offset from) the axial center of the central locator pin. For ease of reference, the fastener through-holes may be labelled using an intuitive classification scheme (e.g., 0:0, −1:+1, −2:+2, −3:+3; A1:A2, B1:B2, C1:C2, etc.). The fastener through-holes may be circular, elliptical, or square and share the same size. Ribs may be added on an underside of the bracket body to structurally reinforce the fastener holes and to provide additional load-bearing capacity for the mated parts. The number of paired fastener holes may also be scaled up or down depending on the intended application of the bracket.

Aspects of this disclosure are directed to rotary-dial mounting brackets for aligning complementary parts during part-to-part assembly. In an example, a mounting bracket is presented for assembling a first component (e.g., a door inner carrier panel) with a second component (e.g., a door support frame). The first component includes multiple threaded holes (e.g., two threaded receiver bosses) that each receives a respective threaded fastener (e.g., panhead bolt), and the second component includes a pin aperture (e.g., circular boss-receiving hole). The mounting bracket includes a bracket body that is rotatable with respect to and interposed between the two components. The bracket body defines therethrough an array of fastener holes, each of which passes a threaded fastener through the fastener hole and into one of the threaded holes to thereby fasten the mounting bracket to the first component. Projecting from a central region of the bracket body is a locator pin that is circumscribed by the array of fastener holes. This locator pin inserts into the pin aperture to thereby attach the mounting bracket and the first component to the second component. A first pair of the bracket's fastener holes is located diametrically opposite from each other across the locator pin; both of these fastener holes are located a shared radial (first) distance from the locator pin. Likewise, a second pair of the fastener holes is located diametrically opposite from each other across the locator pin; however, each of these fastener holes is located a distinct (second) distance from the locator pin.

Additional aspects of this disclosure are directed to motor vehicles with multilayer panel structures assembled together using a radial dial mounting bracket for ensuring proper part-to-part alignment. As used herein, the terms “vehicle” and “motor vehicle” may be used interchangeably and synonymously to include any relevant vehicle platform, such as passenger vehicles, commercial vehicles, industrial vehicles, tracked vehicles, off-road and all-terrain vehicles (ATV), motorcycles, farm equipment, aircraft, watercraft, spacecraft, etc. In an example, a motor vehicle includes a vehicle body with a passenger compartment, multiple road wheels attached to the vehicle body (e.g., via corner modules coupled to a unibody or body-on-frame chassis), and other standard original equipment. A prime mover, which may be in the nature of an electric traction motor and/or an internal combustion engine (ICE) assembly, is located inside the vehicle body and drives the road wheel(s) to propel the vehicle. One or more vehicle door assemblies are movably mounted to the vehicle body to selectively rotate between open and closed positions.

Continuing with the discussion of the above example, each of the vehicle door assemblies includes an inner carrier panel with a pair of threaded holes that receives a pair of threaded fasteners, a metal-stamped door support frame with a pin aperture, and a mounting bracket aligning the inner carrier panel with the door support frame. The mounting bracket includes a bracket body that is interposed between and rotatable with respect to the inner carrier panel and the door support frame. The bracket body defines therethrough a circular array of fastener holes. The pair of threaded fasteners passes through one pair of the fastener holes in the bracket body and into the pair of threaded holes of the inner carrier panel to thereby mount the mounting bracket to the carrier panel. Projecting from a central region of the bracket body is a locator pin that is circumscribed by the circular array of fastener holes. The locator pin is seated in the pin aperture of the door support frame to thereby mount the mounting bracket and the carrier panel to the support frame. The circular array of fastener holes are mated in multiple pairs, including: (1) a first pair of holes (“paired first holes”) located diametrically opposite from each other across the locator pin, spaced a shared hole-to-hole distance from each other, and both located a shared first distance from the locator pin; and (2) a second pair of holes (“paired second holes”) located diametrically opposite from each other across the locator pin, spaced the shared hole-to-hole distance from each other, and each located a respective second distance from the locator pin.

Further aspects of this disclosure are directed to vehicle panel assemblies and control processes for making or for using such vehicle panel assemblies. In an example, a method is presented for manufacturing a mounting bracket for assembling two components. The first component includes threaded holes that receive threaded fasteners, and the second component includes a pin aperture. This representative method includes, in any order and in any combination with any of the above and below disclosed options and features: forming a bracket body rotatable with respect to the first and second components; forming a circular array of fastener holes through the bracket body, each of the fastener holes configured to pass one of the threaded fasteners therethrough and into one of the threaded holes to thereby mount the bracket body to the first component; and forming a locator pin projecting from a central region of the bracket body and circumscribed by the circular array of fastener holes, the locator pin configured to insert into the pin aperture to thereby mount the bracket body and the first component to the second component, wherein the circular array of fastener holes includes paired first holes located diametrically opposite from each other across the locator pin and both located a shared first distance from the locator pin, and paired second holes located diametrically opposite from each other across the locator pin and each located a respective second distance from the locator pin.

For any of the disclosed mounting brackets, vehicles, and methods, each mated pair of the bracket body's fastener holes may be spaced the same shared hole-to-hole distance from each other (i.e., the vertical distance between the threaded holes in the first component). In contrast, the respective “radial” distances to the locator pin of the holes in the second, third, fourth, etc. pairs of fastener holes may all be distinct from each other and distinct from the shared “radial” distance of the holes in the first pair. For instance, the array of fastener holes in the bracket body may further include a third pair of holes (“paired third holes”) located diametrically opposite from each other across the locator pin, spaced the shared hole-to-hole distance from each other, and each located a distinct (third) distance from the locator pin. The respective distances of the third holes to the locator pin are distinct from each other, distinct from the shared first distance of the first holes, and distinct from the respective second distances of the second holes.

For any of the disclosed mounting brackets, vehicles, and methods, the bracket body and the locator pin are integrally formed (e.g., via molding, casting, printing, precision machining, etc.) as a unitary, single-piece structure from a rigid polymeric or metallic material. As a further option, the locator pin may be a hollow, frustoconical boss that projects substantially orthogonally from a central region of the bracket body. Passing threaded fasteners through the first pair of holes in the bracket body and into the threaded holes of the first component securely fastens the mounting bracket at a first location on the first component (e.g., with a zero (0) mm vertical offset relative to the carrier panel's boss-receiving holes). Comparatively, passing threaded fasteners through the second pair of holes and into the threaded holes mounts the bracket body at a second location, distinct from the first location, on the first component (e.g., with a one (+1) mm vertical offset relative to the carrier panel's boss-receiving holes). Mounting bracket designs with eight fastener holes mated in four distinct pairs, for example, may enable the bracket body to mount at seven (7) distinct locations on the first component (e.g., +3 mm, +2 mm, +1 mm, 0 mm, −1 mm, −2 mm, and −3 mm).

For any of the disclosed mounting brackets, vehicles, and methods, the mounting bracket may also include a set of support ribs that project axially from at least one axial face of the bracket body to structurally reinforce the mounting bracket. For instance, the bracket body may include an annular rib and multiple linear ribs that are integral with and project radial inward and/or outward from the annular rib. The annular rib may be a polyhedral ring with a hexadecagonal plan-view profile. The linear ribs may include multiple rib pairs, each of which projects inwards from the annular rib and sandwiches therebetween a respective one of the fastener holes. The bracket body may be a substantially flat plate with filleted edges. As a further option, the reinforcement ribs may project substantially orthogonally from a carrier-plate-facing (first) axial face of the bracket body, whereas the locator pin may project substantially orthogonally from a support-frame-facing (second) axial face, opposite that of the support ribs.

For any of the disclosed mounting brackets, vehicles, and methods, the fastener holes may be arranged in a circular array. In this instance, a circular center of the circular fastener array may be non-concentric with respect to an axial center of the locator pin. As a further option, a plan-view profile of the bracket body may be asymmetrical. In contrast, a side-view profile of the bracket body may be symmetrical. It may also be desirable that all of the fastener holes of the bracket body share a common circular shape with a shared radial size (e.g., circular counterbore holes with 3 mm diameter). As yet a further option, the bracket body may define therethrough as few as two mated pairs of fastener holes or, alternatively, three or more mated pairs of fastener holes.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is an elevated, perspective-view illustration of a representative motor vehicle with an inset view showing a partially exploded illustration of an inner carrier panel mounted onto a door frame panel of a vehicle door assembly via a rotary-dial mounting bracket in accordance with aspects of the present disclosure.

FIG. 2 is an enlarged, top perspective-view illustration of the representative rotary-dial mounting bracket of FIG. 1.

FIG. 3 is an enlarged, bottom perspective-view illustration of the representative rotary-dial mounting bracket of FIG. 1.

FIG. 4 is a plan-view illustration of the representative rotary-dial mounting bracket of FIG. 1.

FIG. 5 is a cross-sectional, side-view illustration of the inner carrier panel mounted onto the door frame panel via the rotary-dial mounting bracket of FIG. 1.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

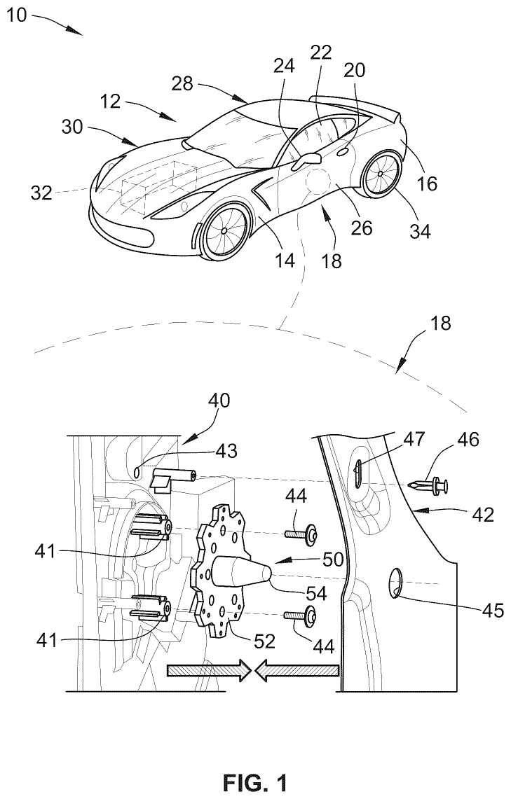

Referring now to the drawings, wherein like reference numbers refer to like features throughout the several views, there is shown in FIG. 1 a representative motor vehicle, which is designated generally at 10 and portrayed herein for purposes of discussion as a couple-style, two-seater automobile. The illustrated automobile 10—also referred to herein as “motor vehicle” or “vehicle” for short—is merely an exemplary application with which aspects of this disclosure may be practiced. In the same vein, implementation of the present concepts for a front driver-side vehicle door assembly should be appreciated as a non-limiting implementation of disclosed features. As such, it will be understood that aspects of this disclosure may be employed for other part-to-part alignment and assembly operations, may be implemented for other vehicle door assembly architectures, and may be incorporated into any logically relevant type of motor vehicle. Moreover, only select components of the motor vehicle and vehicle door assembly are shown and described in detail herein. Nevertheless, the vehicles and door assemblies discussed below may include numerous additional and alternative features, and other available peripheral hardware, for carrying out the various methods and functions of this disclosure.

Mounted along port and starboard-side flanks of the automobile 10, e.g., framed within a respective door sill (not visible) located between a front fender panel 14 and a rear quarter panel 16 of a vehicle body 12, are driver-side and passenger-side vehicle door assemblies (only the former of which is visible in FIG. 1 and designated generally at 18). It should be appreciated that the driver-side and passenger-side vehicle door assemblies may be substantially structurally identical, mirrored counterparts to each other; as such, all features described herein with respect to the driver-side door assembly 18 may be likewise incorporated into the passenger-side door assembly. By way of non-limiting example, the driver-side door assembly 18 is constructed with an exterior door handle 20, a movable glass windowpane 22, and a rearview mirror module 24 that is located on an exterior “A-surface” cover panel 26. The vehicle door assembly 18 of FIG. 1 can be pivotably mounted, e.g., via a multi-stage check-spring door hinge (not visible), to a front body hinge pillar (also not visible) of the vehicle body 12 to securely close and, when desired, open the door assembly 18 to provide access to the vehicle passenger compartment 28. To propel the automobile 10, an internal combustion engine assembly 32 is mounted inside an engine bay 30 and is operable to generate and deliver tractive torque to one or more of the vehicle's road wheels 34.

Presented within the inset view of FIG. 1 is a partially exploded, perspective-view illustration of select components of the driver-side vehicle door assembly 18, namely an inner carrier panel 40 (also referred to as “unit carrier plate” or “first component”) that is aligned with and mounted onto a door support frame 42 (also referred to as “inner support panel” or “second component”) via a rotary-dial mounting bracket 50. Unlike many conventional component locating and alignment features, which are either fixed features integral with one of the parts being assembled, are multipart devices, or require complex tooling, the mounting bracket 50 is a single-piece unit that is small, inexpensive, lightweight and simple to install while offering a scalable and robust solution. Moreover, the mounting bracket 50 may be employed for assembling the internal hardware of a vehicle door assembly (as shown) or may be adapted for aligning and constructing other multi-component assemblies in both vehicular and non-vehicular applications alike.

The inner carrier panel 40 may be a constituent part of a door hardware module, acting as an internal support substrate for physically carrying many of the mechanical, electromechanical, and electrical subsystems of the door assembly 18. Carrier panel 40 may be of a one-piece, vacuum-formed or injection-molded plastic construction, which allows for the mounting and testing of the various door subsystems at a supplier factory or other offsite location, and the subsequent transport of the preassembled door hardware module for rapid installation into the vehicle door assembly 18 at an OEM facility. In a few non-limiting examples, the inner carrier panel 40 may support thereon one or more acoustic speakers, a door lock assembly, and a wiring harness, each of which may be mounted to a dedicated, integrally molded structural element of the door hardware module's unit carrier plate 40.

With continuing reference to FIG. 1, the door support frame 42 may primarily function as the load-bearing structural member of the vehicle door assembly 18, e.g., transferring loads to fore and aft door frame pillars (commonly referred to as the “A-pillar” and “B-pillar”). Vehicle door assembly 18 is of a multilayer construction with the door support frame 42 sandwiched between, and providing physical support for, the exterior cover panel 26, the inner carrier panel 40, and an interior “A-surface” trim panel (not visible). While certainly amendable to multi-piece constructions, the illustrated inner support panel 42 may be integrally formed as a single-piece unitary structure, e.g., via stamping, casting, thermoforming, hydroforming, etc. It may be desirable, depending on the intended application, to blank cut and die stamp the inner support panel 42 from a more robust, weightier metal, such as steel and alloys thereof, or a lightweight metal, such as aluminum or magnesium.

To facilitate mounting of the carrier panel 40 to the support frame 42, the inner carrier panel 40 may be fabricated with an assortment of threaded holes and clip apertures for receiving threaded fasteners, fastening clips, and the like. In accord with the illustrated example, a pair of internally threaded receiver bosses 41 is integrally formed with and projects transversely from an outboard surface of the carrier panel 40. Each upstanding receiver boss 41 receives therein and threadably mates with a respective threaded fastener, such as panhead bolts 44 of FIG. 1. A clip hole 43 is also integrally formed with and projects transversely from the carrier panel's 40 outboard surface; this clip hole 43 receives a clip-type fastener, such as a trim rivet clip 46. It should be appreciated that the number, type, and placement of the threaded holes and clip apertures may be varied to accommodate the design parameters of other intended applications.

To further facilitate assembly of the support frame 42 with the carrier panel 40, the door support frame 42 may be fabricated with a pin aperture, such as a circular, boss-receiving through-hole 45, that structurally couples with the mounting bracket 50. It may be desirable that the through-hole 45 have a predefined clearance (e.g., approximately 0.1 mm radial buffer) to facilitate mating of the mounting bracket 50 with the door support frame 42. Support frame 42 may also be fabricated with an elongated clip slot 47 that receives therethrough the trim rivet clip 46 for fastening the door support frame 42 to the inner carrier panel 40. Similar to the carrier panel's threaded holes and clip apertures, the number, type, and placement of the pin apertures and clip holes may be varied to accommodate the design parameters of other intended applications. It is further envisioned that the carrier panel 40 may include the pin apertures and clip holes and the support frame 42 include the threaded holes and clip apertures, e.g., for applications in which the rotary-dial mounting bracket 50 is bolted to the frame 42 and inserted into the panel 40.

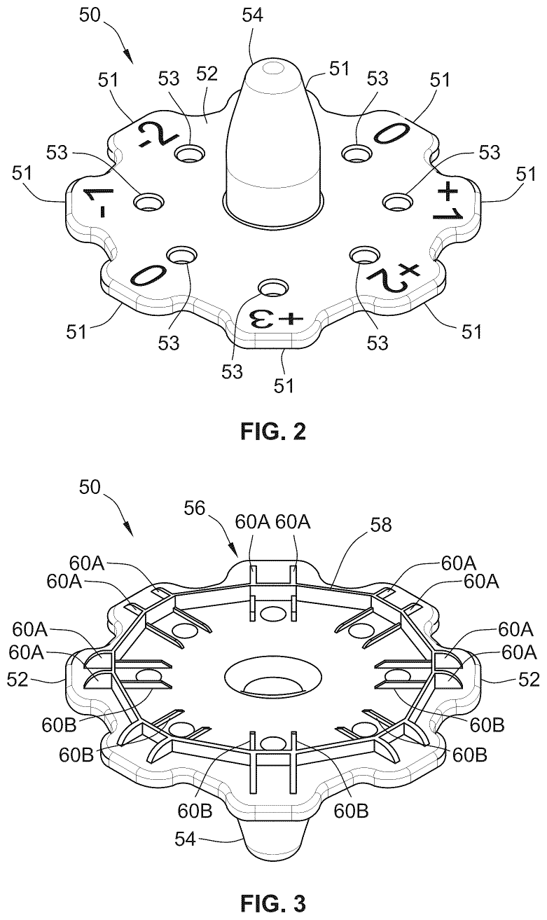

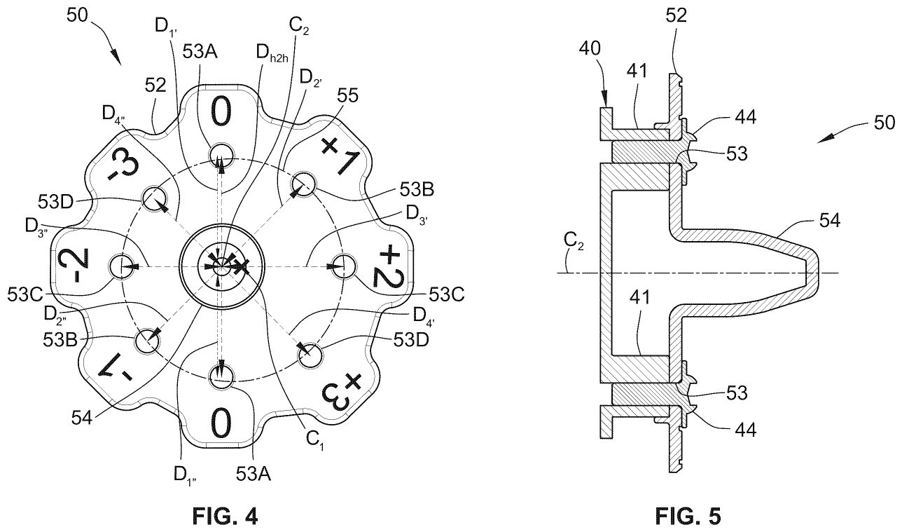

The rotary-dial mounting bracket 50 helps to provide precision part-to-part alignment and mounting when assembling the unit carrier plate 40 with the inner support panel 42. The mounting bracket 50 may be typified by two primary segments: (1) a round bracket body 52, and (2) a central locator pin 54 that projects from a central region of the bracket body 52. As best seen in the inset view of FIG. 1, the mounting bracket body 52 may be a substantially flat, plate-like structure that is sandwiched between and rotatable with respect to the two mating components 40 and 42. FIG. 4 shows that the bracket body 52 may have an asymmetrical plan-view profile with filleted edges; FIG. 5, on the other hand, shows that the bracket body 52 may have a symmetrical side-view profile (e.g., when sectioned through the 0:0 origin pair). The mounting bracket 50 may have optional spur-gear-like teeth 51 (FIG. 2) that are spaced around and project radially outward from the perimeter of the bracket body 52. It is also envisioned that the bracket body 52 may take on other regular and irregular shapes and a variety of different sizes without departing from the intended scope of this disclosure.

Locator pin 54 of FIG. 1 projects axially outboard from the bracket body 52 and inserts into the pin aperture 45 of the support frame 42 to thereby attach the mounting bracket 50 and carrier panel 40 to the support frame 42. While not per se limited, the locator pin 54 may be a hollow, frustoconical boss that projects substantially orthogonally from the central region of the bracket body 52. The locator pin 54 may function as the axial center of the mounting bracket 50 about which rotates the bracket body 52. While it is plausible to fabricate the mounting bracket 50 is a multipiece device, it may be desirable to integrally form the bracket body 52 and locator pin 54 as a single-piece structure from a rigid polymeric and/or metallic material (e.g., Acrylonitrile Butadiene Styrene (ABS) or 6061 aluminum alloy).

To securely fasten the mounting bracket 50 to the carrier panel 40, the bracket body 52 is fabricated with an array of fastener through-holes 53, each of which passes therethrough a respective threaded fastener, such one of the panhead bolts 44 of FIG. 1. As best seen in FIG. 4, the bracket body 52 may define therethrough eight (8) fastener holes 53 that are arranged in a circular array 55 that circumscribes the locator pin 54. In this non-limiting example, a circular center C₁ of the circular fastener array 55 may be eccentric with (i.e., radially offset from) an axial center C₂ of the locator pin 54. It may also be desirable that all of the fastener holes 53 of the bracket body 52 share a common circular shape with a shared radial size (e.g., circular counterbore holes with 3 mm diameter). The mounting bracket 50 may be scaled up or scaled down to include greater or fewer than eight fastener holes, which may be arranged in similar or different patterns than that which is shown in the Figures.

With reference next to FIG. 4, the circumferentially spaced fastener holes 53 may be matched in distinct fastener hole pairs in which the holes of each pair are located diametrically opposite each other across the central locator pin 54. In accord with the illustrated example, the fastener hole array 53 includes a first pair of holes 53A (also referred to herein as “paired first holes” or “0:0 origin pair”) in which the holes 53A are located diametrically opposite from each other across the locator pin 54, are spaced a shared hole-to-hole distance Dₕ₂ₕ from each other (e.g., Dₕ₂ₕ=XX.X mm) and are both located the same “shared” first distance D_{1′} and D_{1″} to the center of the locator pin 54 (e.g., D_{1′}=D_{1″}; D_{1′}+D_{1″}=Dₕ₂ₕ). Similar to the first pair 53A, a second pair of fastener holes 53B (also referred to herein as “paired second holes” or “−1:+1 offset pair”) comprises two holes 53B that are located diametrically opposite from each other across the locator pin 54 and spaced the same shared distance Dₕ₂ₕ from each other (shared distance Dₕ₂ₕ only shown once in FIG. 4 to avoid cluttering and obfuscating the Figure). In contrast to the first pair of holes 53A, however, each hole 53B in the second pair has a respective “radial” (second) distance D_{2′} to the center of the locator pin 54 that is distinct from the other hole's respective radial distance D_{2″} and are both distinct from the shared (first) distance of the first holes 53A (e.g., D_{2′}>D_{1′}=D_{1″}>D_{2″}; D_{2′}+D_{2″}=Dₕ₂ₕ).

Continuing with the foregoing discussion of the paired fastener holes, a third pair of holes 53C (also referred to herein as “paired third holes” or “−2:+2 offset pair”) comprises holes 53C are located diametrically opposite from each other across the locator pin 54 and spaced the same shared hole-to-hole distance Dₕ₂ₕ from each other. Each fastener hole 53C has a respective “radial” (third) distance D_{3′} D_{3″} to the center of the locator pin 54 that is distinct from the other hole's respective radial distance D_{3″} and are both distinct from the first and second distances of the first and second paired holes 53A and 53B (e.g., D_{3′}>D_{2′}>D_{1′}; D_{1″}>D_{2″}>D_{3″}; D_{3′}+D_{3″}=Dₕ₂ₕ). A fourth pair of holes 53D (also referred to herein as “paired fourth holes” or “−3:+3 offset pair”) comprises holes 53D that are located diametrically opposite from each other across the locator pin 54 and spaced the same shared hole-to-hole distance Dₕ₂ₕ from each other as the other paired holes 53A-53C. Each fastener hole 53D has a respective “radial” (fourth) distance D_{4′} and D_{4″} to the center of the locator pin 54 that are distinct from each other and distinct from the first, second and third distances of the first, second and third paired holes 53A-53C (e.g., D_{4′}>D_{3′}>D_{3″}>D_{4″}; D_{4′}+D_{4″}=Dₕ₂ₕ).

By rotating the mounting bracket 50 with respect to the two mating components 40, 42, the distances between the two vertical-most holes 53 that align with the threaded receiver bosses/holes 41 and the pin locator 54 are changed with a concomitant modification to the relative positions between the components 40, 42. Passing the threaded fasteners 44 through the first pair of holes 53A in the bracket body 52 and into the threaded holes 41 of the inner carrier panel 40, for example, securely fastens the mounting bracket 50 at a first location on the carrier panel 40 (e.g., with a zero (0) mm vertical offset relative to the carrier panel's boss-receiving holes 41). Comparatively, rotating the mounting bracket 50, e.g., counterclockwise approximately 45 degrees (°) in FIG. 4, and passing the threaded fasteners 44 through the second pair of holes 53B and into the threaded holes 41 will fasten the mounting bracket 50 at a second location, distinct from the first location, on the carrier panel 40 (e.g., with a one (+1) mm vertical offset relative to the carrier panel's boss-receiving holes 41). Conversely, rotating the mounting bracket 50 in the opposite direction, e.g., clockwise approximately 45° in FIG. 4, and passing the threaded fasteners 44 through the fourth pair of holes 53D in the bracket body 52 and into the threaded holes 41 of the carrier panel 40 will fasten the mounting bracket 50 at a distinct third location on the panel 40 (e.g., with a three (−3) mm vertical offset relative to the carrier panel's boss-receiving holes 41).

Rotary-dial mounting bracket 50 designs with eight fastener holes 53 mated in four distinct pairs 53A-53D may enable the bracket body 52 to mount at seven (7) distinct locations on the carrier panel 40 (e.g., +3 mm, +2 mm, +1 mm, 0 mm, −1 mm, −2 mm, and −3 mm). Optional symbols may be placed next to each of the holes 53 to mark the desired adjustment position which corresponds to that hole. When the mounting bracket 50 is rotated, the fastener hole 53 located at the top (twelve-o-clock) position may dictate the desired adjustment value for aligning and mounting the inner carrier panel 40 with the door support frame 42. Alternative applications may align the threaded holes 41 in horizontal or other non-vertical orientations such that rotating the mounting bracket 50 will result in a horizontal/non-vertical realignment of the two mating components 40, 42.

Turning next to FIG. 3, the mounting bracket 50 may be fabricated with a set of support ribs 56 that projects axially from one or both axial faces of the bracket body 52, e.g., to structurally reinforce the mounting bracket 50. For instance, the reinforcing support ribs 56 may be typified by an annular support rib 58 that circumscribes the fastener holes 53 and the locator pin 54. This annular rib 58 may be a polyhedral ring with a hexadecagonal plan-view profile. The support ribs 56 may also include multiple linear support ribs 60A and 60B that are integral with and project radial inward and/or radial outward from the annular rib 58. For instance, multiple pairs of outer ribs 60A are circumferentially spaced around the bracket body 52 and project radially outward from the annular rib 58, e.g., to structurally reinforce the mounting bracket body 52. Multiple pairs of inner ribs 60B are likewise circumferentially spaced around the bracket body 52; each pair of inner ribs 60B projects inwards from the annular rib 58 and sandwiches therebetween a respective one of the fastener holes 53. In accord with the illustrated example, the reinforcement support ribs 56 may project substantially orthogonally from a carrier-plate-facing (first) axial face of the bracket body 52, whereas the locator pin 54 may project substantially orthogonally from a support-frame-facing (second) axial face, opposite that of the support ribs.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A mounting bracket for assembling a first component with a second component, the first component including threaded holes configured to receive threaded fasteners, and the second component including a pin aperture, the mounting bracket comprising:
a bracket body rotatable with respect to the first and second components and defining therethrough an array of fastener holes, each of the fastener holes configured to pass one of the threaded fasteners therethrough and into one of the threaded holes to thereby mount the bracket body to the first component; and
a locator pin projecting from a central region of the bracket body and circumscribed by the array of fastener holes, the locator pin configured to insert into the pin aperture to thereby mount the bracket body and the first component to the second component,
wherein the array of fastener holes includes paired first holes located diametrically opposite from each other across the locator pin and both located a shared first distance from the locator pin, and paired second holes located diametrically opposite from each other across the locator pin and each located a respective second distance from the locator pin.

2. The mounting bracket of claim 1, wherein the first holes are spaced a shared hole-to-hole distance from each other, and the second holes are spaced the shared hole-to-hole distance from each other.

3. The mounting bracket of claim 1, wherein the respective second distances of the second holes are distinct from each other and distinct from the shared first distance of the first holes.

4. The mounting bracket of claim 3, wherein the array of fastener holes further includes paired third holes located diametrically opposite from each other across the locator pin and each located a respective third distance from the locator pin, wherein the respective third distances of the third holes are distinct from each other, distinct from the shared first distance of the first holes, and distinct from the respective second distances of the second holes.

5. The mounting bracket of claim 1, wherein the bracket body and the locator pin are integrally formed as a single-piece structure from a rigid polymeric or metallic material.

6. The mounting bracket of claim 1, wherein the locator pin is a frustoconical boss projecting substantially orthogonally from a central region of the bracket body.

7. The mounting bracket of claim 1, wherein passing a pair of the threaded fasteners through the first holes of the bracket body and into the threaded holes of the first component mounts the bracket body at a first location on the first component, and passing the pair of the threaded fasteners through the second holes and into the threaded holes mounts the bracket body at a second location, distinct from the first location, on the first component.

8. The mounting bracket of claim 1, further comprising a plurality of support ribs projecting axially from a first axial face of the bracket body and configured to structurally reinforce the mounting bracket.

9. The mounting bracket of claim 8, wherein the plurality of support ribs includes an annular rib and multiple linear ribs integral with and projecting radial from the annular rib.

10. The mounting bracket of claim 8, wherein the bracket body is substantially flat, the support ribs project substantially orthogonally from the first axial face of the bracket body, and the locator pin projects substantially orthogonally from a second axial face, opposite the first axial face, of the bracket body.

11. The mounting bracket of claim 1, wherein the array of fastener holes is circular with a circular center eccentric with respect to an axial center of the locator pin.

12. The mounting bracket of claim 1, wherein a plan-view profile of the bracket body is asymmetric.

13. The mounting bracket of claim 1, wherein the fastener holes of the bracket body share a common circular shape with a shared radial size.

14. A motor vehicle, comprising:
a vehicle body;
a plurality of road wheels attached to the vehicle body;
a prime mover attached to the vehicle body and configured to drive at least one of the road wheels to thereby propel the motor vehicle; and
a vehicle door assembly movably attached to the vehicle body, the vehicle door assembly including an inner carrier panel with a pair of threaded holes configured to receive a pair of threaded fasteners, a door support frame with a pin aperture, and a mounting bracket aligning the inner carrier panel with the door support frame, the mounting bracket comprising:
a bracket body interposed between and rotatable with respect to the inner carrier panel and the door support frame, the bracket body defining therethrough a circular array of fastener holes, the pair of threaded fasteners passing through a select pair of the fastener holes and into the pair of threaded holes to thereby mount the bracket body to the inner carrier panel; and
a locator pin projecting from a central region of the bracket body and circumscribed by the circular array of fastener holes, the locator pin seated in the pin aperture to thereby mount the bracket body and the inner carrier panel to the door support frame,
wherein the circular array of fastener holes includes:
a first pair of holes located diametrically opposite from each other across the locator pin, spaced a shared hole-to-hole distance from each other, and both located a shared first distance from the locator pin; and
a second pair of holes located diametrically opposite from each other across the locator pin, spaced the shared hole-to-hole distance from each other, and each located a respective second distance from the locator pin.

15. A method of manufacturing a mounting bracket for assembling first and second components, the first component including threaded holes configured to receive threaded fasteners, and the second component including a pin aperture, the method comprising:
forming a bracket body rotatable with respect to the first and second components;
forming a array of fastener holes through the bracket body, each of the fastener holes configured to pass one of the threaded fasteners therethrough and into one of the threaded holes to thereby mount the bracket body to the first component; and
forming a locator pin projecting from a central region of the bracket body and circumscribed by the array of fastener holes, the locator pin configured to insert into the pin aperture to thereby mount the bracket body and the first component to the second component,
wherein the array of fastener holes includes paired first holes located diametrically opposite from each other across the locator pin and both located a shared first distance from the locator pin, and paired second holes located diametrically opposite from each other across the locator pin and each located a respective second distance from the locator pin.

16. The method of claim 15, wherein the first holes are spaced a shared hole-to-hole distance from each other, and the second holes are spaced the shared hole-to-hole distance from each other.

17. The method of claim 15, wherein the respective second distances of the second holes are distinct from each other and distinct from the shared first distance of the first holes.

18. The method of claim 17, wherein the array of fastener holes further includes paired third holes located diametrically opposite from each other across the locator pin and each located a respective third distance from the locator pin, wherein the respective third distances of the third holes are distinct from each other, distinct from the shared first distance of the first holes, and distinct from the respective second distances of the second holes.

19. The method of claim 15, wherein forming the bracket body and forming the locator pin includes integrally forming the bracket body and the locator pin as a single-piece structure from a rigid polymeric or metallic material.

20. The method of claim 15, further comprising forming a plurality of support ribs projecting axially from a first axial face of the bracket body and configured to structurally reinforce the mounting bracket.
